(19) United States
(12) Patent Application Publication
(10) Pub. No.: US 2007/0061030 A1
(43) Pub. Date: Mar. 15, 2007

(54) RELIABILITY ANALYSIS SYSTEM AND METHOD

(75) Inventors: Mami NAKADATE, Kawasaki (JP); Nobutaka ITOH, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/275,293

(22) Filed: Dec. 22, 2005

(30) Foreign Application Priority Data
Sep. 9, 2005 (JP) 2005-261601

(51) Int. Cl. G06F 19/00

(52) U.S. Cl. 700/96

(57) ABSTRACT

In order to analyze the reliability of a package, firstly, a manufacturing process analysis simulating unit conducts and analyzes a manufacturing process analysis simulation. Then, a reliability evaluation analysis simulating unit conducts and analyzes reliability evaluation analysis simulation. Each simulation analysis result is reflected in a manufacturing process one after another and manufactures a package. A shipping determination unit final determines whether the manufactured package can be shipped. Thus, an optimal package can be selected by multiplying the reliability analysis which takes into consideration the history of heat given to a package in its manufacturing process, of a material (resin) and a structure (package dimensions) suitable for designed thermal load conditions. Simultaneously, the number and cost of its trial manufacture can be reduced. A package structure which matches the material characteristic of a package can be determined by feedback.

### BACKGROUND OF THE INVENTION

1. Field of the Invention

The present invention relates to a reliability analysis system and a method thereof, and more particularly relates to a reliability analysis system for multiplying reliability analysis which takes into consideration the history of heat given to a material (resin) and structure (package dimensions) suitable for a designed thermal load condition in its manufacturing process and selecting an optimal material and an optimal structure.

2. Description of the Related Art

Conventionally, when manufacturing an IC package, a resin manufacturer gives the physical property values of a used resin and the IC package is designed and manufactured on the condition that the physical property values (except for temperature dependency) do not change, and its manufacturing process is evaluated and analyzed by sampling a variety of manufactured IC packages. Since reliability evaluation is applied to a variety of IC packages and the result of the reliability evaluation is fed back to the purpose of evaluation and analysis of the manufacturing process, generally it takes a lot of days (usually several months to half a year) to design, manufacture and evaluate/analyze an IC package (including reliability evaluation). It is also known that a computer applies a simulation test to a manufactured IC package for the purpose of reliability evaluation (see patent reference 1).

FIG. 1 is a process chart showing the summary of the conventional IC package manufacturing process. The IC package manufacturing process shown in FIG. 1 comprises a process 41 of forming an Au primary bump on an IC and a process 42 of plasma-cleaning a resin substrate, a process 44 of framing the plasma-cleaned resin substrate like a roll of camera-film (i.e. magazine), carrying/supplying it via a loader 43, supplying the carried/supplied resin substrate with an IC mounted on a special tray and ultra sonic (US)-joint them, a process 45 of under-filling (UF) between the US-joined resin substrate and the IC, processes 46 and 47 of primarily and secondarily curing the under-filled resign and IC in a thermostatic stocker, oven or the like, a process 48 of resin-capsuling the secondarily cured substrate and IC, a process 49 of cutting the capsulated IC off the magazine and a process 50 of forming a secondary Au bump on the cut capsulated IC. Then, reliability evaluation 60 is applied to the IC package, and the IC packages which clear the reliability evaluation are shipped. As reliability tests for reliability evaluation 60, a cold-heat impact test, a moisture absorption test, a mechanical cycle test and a drop impact test which are shown in the left corners are applied. In the cold-heat impact test, for example, heat load is given by applying 1,000 cycles of a temperature condition (−60° C.˜125° C.).

Since as seen in FIG. 1, in the manufacturing process of an IC package, a lot of heat load (including processes, such as UF coating and primary and secondary cure, etc.) is given to the material (resin), the resin bends and cracks. Therefore, often a secondary bump cannot be formed even on a suitable material (resin) and it cannot be mounted on a motherboard due to the bending of a manufactured IC package.

This is because even if an IC package is manufactured after conducting a manufacturing process simulation, in an manufacturing process simulation, only temperature-dependent Young's modulus, a stress relaxation characteristic, a linear expansion coefficient are inputted, and a phenomenon that the physical properties of a resin is changed by repeating the giving of heat until the IC package is manufactured, for example, until the resin is baked and shrinks, is not reflected in the manufacturing process. Since IC packages have been manufactured without taking such a heat history into consideration, an unanticipated phenomenon occurred and it took a long time to develop an IC package applicable to actual use.

Since in the manufacturing process of IC packages, even when no damage appears, a variety of reliability evaluation tests applies load including heat load to the IC packages before shipment, some packages are made NG.

Furthermore, since in the manufacturing process of IC packages, reliability evaluation is applied to only IC packages that clear a variety of problems, it takes a long time to design, manufacture and evaluate/analyze an IC package.

Patent reference 1: Japanese Patent Application Publication No. 2000-46905

### SUMMARY OF THE INVENTION

The present invention aims to solve such problems and it is an object of the present invention to provide a reliability analysis system for multiplying reliability analysis which takes into consideration the history of heat given to a material (resin) and structure (package dimensions) suitable for a designed thermal load condition in its manufacturing process and selecting an optimal material and an optimal structure and a method thereof.

In order to solve such problems, the present invention comprises a database for storing time- and temperature-dependency changes due to heat and humidity of a resin material, as physical property data, a manufacturing process analyzing unit for taking in physical property data from the database, based on a predetermined package model and process conditions according to the manufacturing process of an IC package, calculating stress on a specific part of the model and analyzing a heat history aptitude of the package and a reliability evaluation/analysis unit for taking in physical property data from the database, based on predetermined reliability evaluation conditions, calculating stress applied to a specific part of the model and analyzing a heat history aptitude of the package.

According to the present invention, an optimal material (resin) and an optimal structure (package dimensions) which are suitable for a designed heat load condition can be selected by multiplying reliability analysis which takes the history of heat given in the manufacturing process. Simultaneously, the number and cost of trial manufacturing can be reduced. According to the present invention, a package structure which matches the material characteristic of the package can be determined by feedback.

### BRIEF DESCRIPTION OF THE DRAWINGS

FIG. 1 is a process chart showing the summary of the conventional IC package manufacturing process.

FIG. 2 shows the basic configuration of the reliability analysis system in the preferred embodiment of the present invention.

FIG. 3 shows the configuration of the manufacturing process analysis simulating unit in the preferred embodiment of the present invention shown in FIG. 2.

FIG. 4A is a table for showing a curing shrinkage ratio for each elapsing time of resin material samples A and B.

FIG. 4B is a broken-line graph for showing a curing shrinkage ratio for each elapsing time of resin material samples A and B.

FIG. 5 shows the configuration of a reliability evaluation/analysis simulating unit in the preferred embodiment of the present invention shown in FIG. 2.

FIG. 6 is a flowchart showing the summary of reliability analysis method in the preferred embodiment of the present invention.

FIG. 7 is a flowchart showing the detailed reliability analysis method in the preferred embodiment of the present invention.

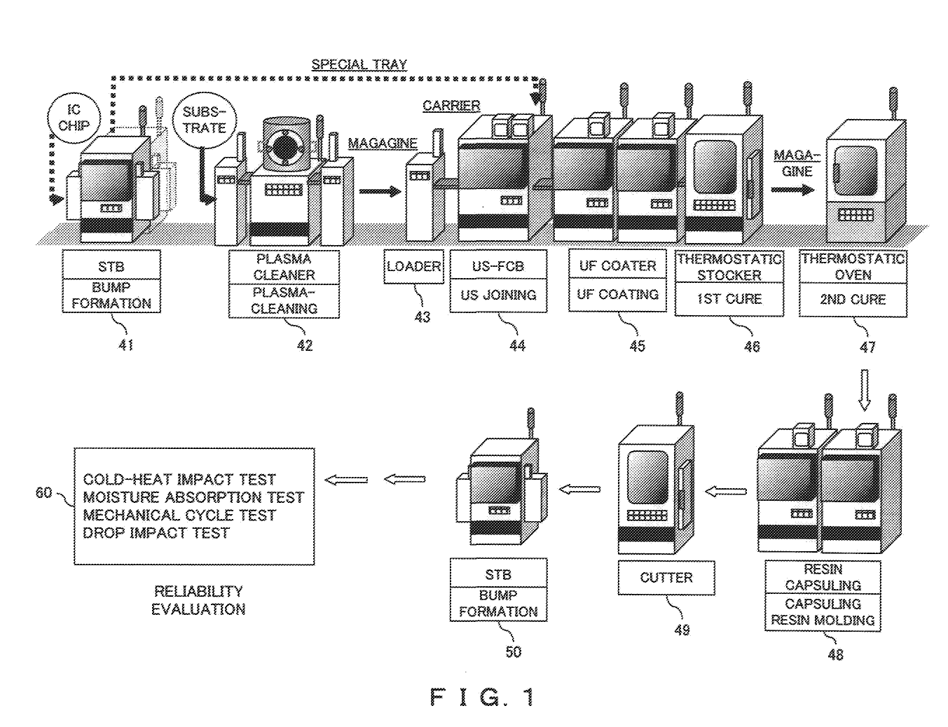

### DESCRIPTION OF THE PREFERRED EMBODIMENT

The preferred embodiment of the present invention is described below with reference to the drawings.

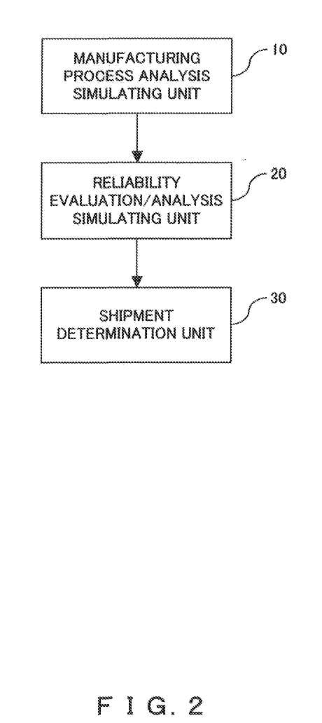

FIG. 2 shows the basic configuration of the reliability analysis system in the preferred embodiment of the present invention. The reliability analysis system in the preferred embodiment of the present invention shown in FIG. 2 comprises a manufacturing process analysis simulating unit 10, a reliability evaluation/analysis simulating unit 20 and a shipment determining unit 30. The manufacturing process analysis simulating unit 10 conducts a manufacturing process analysis simulation which takes a heat history into consideration. The reliability evaluation/analysis simulating unit 20 conducts a reliability evaluation/analysis simulation which takes a heat history into consideration. In order to analysis the reliability of a package, firstly, the manufacturing process analysis simulating unit 10 conducts a manufacturing process analysis simulation and analyzes it, and then, the reliability evaluation/analysis simulating unit 20 conducts a reliability evaluation/analysis simulation and analyzes it. Then, a package is manufactured by reflecting each simulation analysis result in a manufacturing process one after another and the shipment determination unit 30 finally determines whether the manufactured package can be shipped. The shipment determination unit 30 performs reliability evaluation items that are not performed in the above-described reliability evaluation/analysis simulation, such as a mechanical cycle test, a drop impact test and the like and determines whether the package can be shipped. Although as a package, an IC package is described below, it can be also an LSI package.

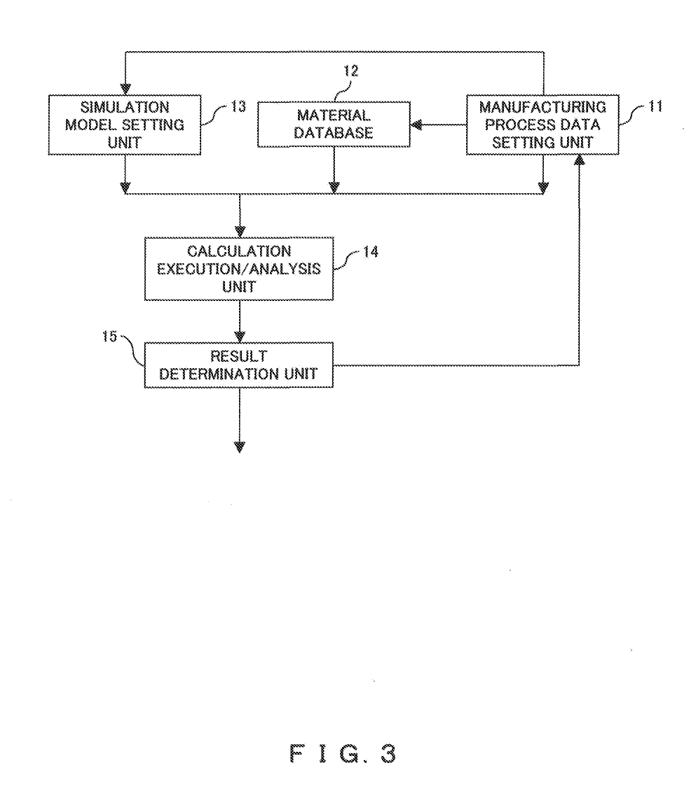

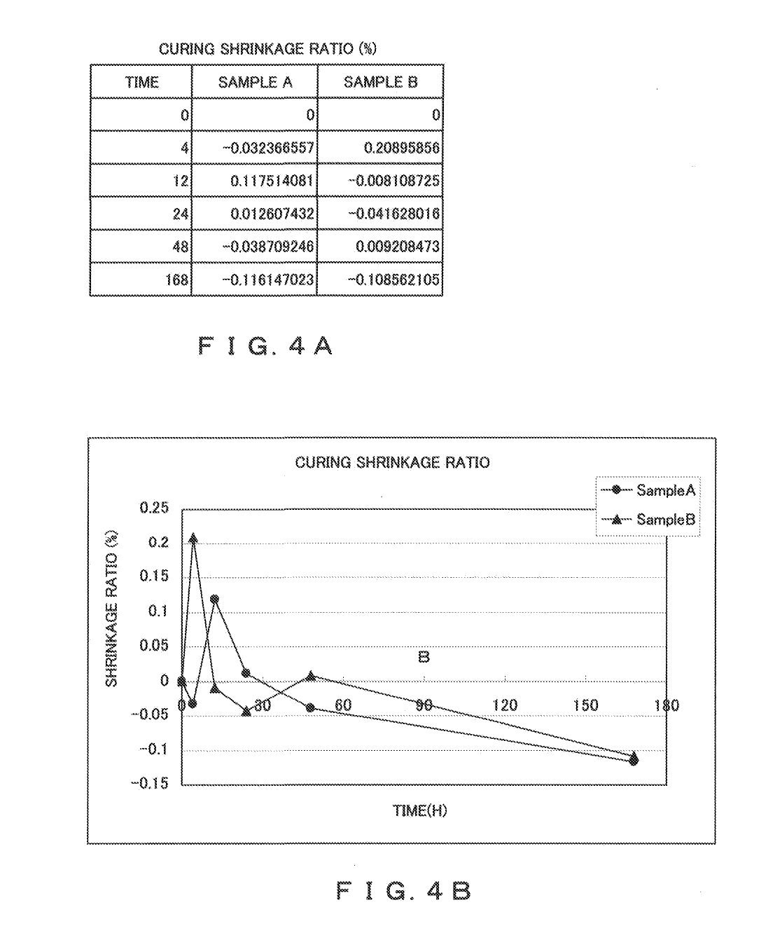

FIG. 3 shows the configuration of the manufacturing process analysis simulating unit in the preferred embodiment of the present invention shown in FIG. 2. As shown in FIG. 3, the manufacturing process analysis simulating unit 10 in this preferred embodiment of the present invention comprises a manufacturing process data setting unit 11 for setting manufacturing process data of manufacturing process conditions and the like, a material database 12 for storing and outputting physical property value which takes the heat history of the material (resin), a simulation model setting unit 13 for outputting the structure of a heat history (dimensions, etc.) as model data, a calculation execution/analysis unit 14 for taking in each temperature- and time-dependent physical value from the material database 12, based on the predetermined model data and manufacturing process data and calculating and analyzing bending and stress applied to a specific part (for example, a chip surface, a bump surface, etc.) of a package, using a calculation method, such a finite element method or the like and a result determination unit 15 for determining whether as a result of the analysis, the stress applied to the specific part of the package exceeds a threshold value (for example, a fracture toughness value of the material). If the finite element method is used, the specific part of the package (for example, a chip surface, a bump surface, etc.) can be specified by its element number or node number. If the result determination unit 15 determines that the stress applied to the specific part of the package exceeds the threshold value, a physical property value where the stress applied to the specific part of the package does not exceed the threshold value is obtained from the material database 12, based on the manufacturing process data fed back to and set in the manufacturing process data setting unit 11. Alternatively, the structure (dimensions, etc.) used in the mode data is changed by the simulation model setting unit 13 and the manufacturing process simulation analysis is performed again. The material database 12 stores not only temperature-dependent Young's modulus, a stress relaxation characteristic and a linear expansion coefficient but also physical properties related to the heat history of a resin material, such as hygroscopic expansion, thermal shrinkage and the like. As shown in FIGS. 4A and 4B, when the manufacturing process receives a resin material sample, the material database 12 obtains in advance a curing shrinkage ratio in accordance with an a predicted heat history, digitizes it and stores it.

FIG. 4A is a table for showing a curing shrinkage ratio for each elapsing time of resin material samples A and B. FIG. 4B is a broken-line graph for showing a curing shrinkage ratio for each elapsing time of resin material samples A and B. In FIGS. 4A and 4B, the curing shrinkage ratios of resin material samples A and B are measured at each elapsing time of measurement commencement (0 H), 4 H, 12 H, 24 H, 48 H and 168 H, and their numerical data (%) is obtained and shown by broken-line graphs. Although the resin samples A and B both takes almost the same curing shrinkage ratio (%) (approximately 0.11% shrank) after 168 H, they differ in a curing shrinkage ratio (%) at the intermediate elapsing times, such as 4 H, 12 H, 24 H and 48 H, specifically, if one expands, the other shrinks. Such shrinkage ratio data (%) at each elapsing time is added to temperature-dependent Young's modulus, a stress relaxation characteristic, a linear expansion coefficient as one factor of the physical property value and are stored in the material database 12 shown in FIG. 3. In this way, the table and graph of the curing shrinkage ratio shown in FIGS. 4A and 4B, respectively, shows that a resin material sample is baked and shrinks in the manufacturing process of a package and its physical property varies, and it is also stored in advance in the material database 12 shown in FIG. 3 as one physical property value.

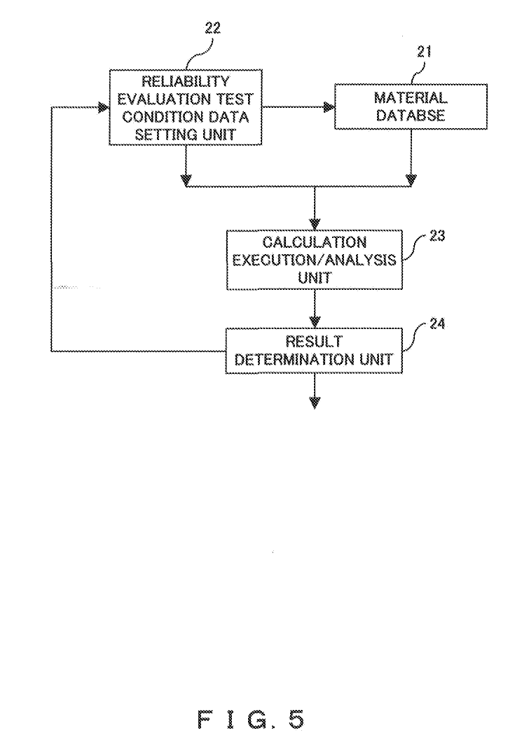

FIG. 5 shows the configuration of a reliability evaluation/analysis simulating unit in the preferred embodiment of the present invention shown in FIG. 2. As shown in FIG. 5, the reliability evaluation/analysis simulating unit 20 of the present invention comprises a material database 21 for storing and outputting physical property values in which the heat history of a material (resin) is taken into consideration, a reliability evaluation test condition data setting unit 22 for setting reliability evaluation test conditions, a calculation execution/analysis unit 23 for taking in physical property data in which the heat history of a material (resin) is taken into consideration from the material database 21, based on predetermined reliability evaluation test condition data, calculating reliability evaluation items, such as stress applied to the specific part of a package, using a calculation method, such as a finite element method or the like, and a result determination unit 24 for determining as a result of the analysis whether the stress applied to the specific part of the package exceeds a threshold value (for example, the fracture toughness value of a material). If the result determination unit 24 determines that the stress applied to the specific part of the package exceeds the threshold value, the result determination unit 24 feeds back the determination result to the reliability evaluation test condition data setting unit 22, takes in physical property data where the stress applied to the specific part of the package does not exceed the threshold value from the material database 21, based on the predetermined reliability evaluation test condition data, also takes in new reliability evaluation test condition data again and performs reliability evaluation test analysis again. In this case, the material database 21 shown in FIG. 5 can be the same as the material database 12 shown in FIG. 3. Alternatively, they can be provided separately. If the result determination unit 24 determines that the stress applied to the specific part of the package greatly exceeds the threshold value, the process returns to FIG. 3 to conduct the manufacturing process analysis simulation again, then to conduct the reliability evaluation analysis simulation again and to obtain an optimal package.

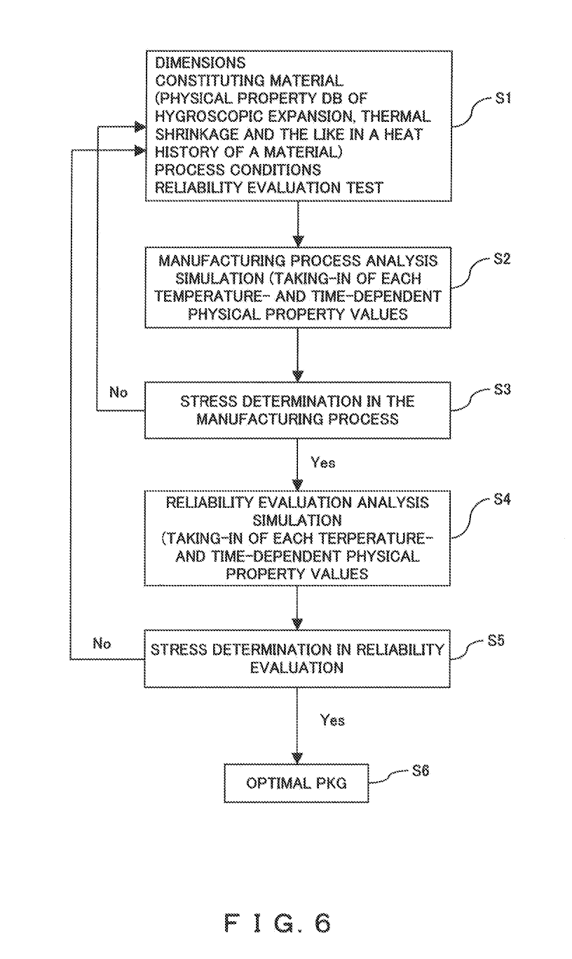

FIG. 6 is a flowchart showing the summary of reliability analysis method in the preferred embodiment of the present invention. In FIG. 6, in step (omitted “S” in FIG. 6) 1, the manufacturing process data setting unit 11 and the simulation model setting unit 13 which are shown in FIG. 3, set manufacturing process condition (manufacturing process data) and dimensions (model data), respectively, and the reliability evaluation test condition data setting unit 22 shown in FIG. 5 sets reliability evaluation test conditions. Then, the set process condition (manufacturing process data) is dimensions (model data) are obtained, and physical property data including the hygroscopic expansion, thermal shrinkage and the like of a constituting material is also obtained from the material database 12.

In step 2, the process condition (manufacturing process data) and dimensions (model data) which are set in step 1 and the temperature- and time-dependent physical property data of each process stored in the material database 12 are taken in a computer, and the manufacturing process analysis simulation for calculating stress applied to the specific part of a package, using a calculation method, such as a finite element method or the like, is conducted. Then, in step 3, it is determined whether the stress applied to the specific part of the package in the manufacturing process is located below a prescribed threshold value (for example, the fracture toughness value of a material) and the heat history aptitude of the package is determined. If the stress applied to the specific part of the package exceeds the prescribed threshold value, it is determined that the heat history aptitude of the package is insufficient and the process returns to step 1. Then, after the dimensions, constituting material, process conditions and the like are selectively modified, steps 2 and 3 are executed again.

If in step 3, it is determined that the stress applied to the specific part of the package is located below the prescribed threshold value, it is determined that the heat history aptitude of the package is sufficient and the process proceeds to step 4. In step 4, reliability evaluation analysis simulation is conducted. In the reliability evaluation analysis simulation, each piece of temperature- and time-dependent physical property data stored in the material database 21, of a cold-heat impact test, a moisture absorption test and the like, are taken in, based on the reliability evaluation test conditions set in step 1, and reliability evaluation analysis simulation for calculating stress applied to the specific part, using a calculation method, such as a finite element method or the like, is conducted. Then, in step 5, it is determined the stress applied to the specific part of the package in the reliability evaluation is located below a prescribed threshold value (for example, the fracture toughness value of a material). If it is determined that the stress applied to the specific part of the package greatly exceeds the threshold value, it is determined that the heat history aptitude of the package is insufficient and the process returns to step 1. Then, after the dimensions, constituting material, process conditions and the like are selectively modified, steps 2 and 3 are executed again. If in step 5, it is determined the stress applied to the specific part of the package is located below the prescribed threshold value, it is determined that the heat history aptitude of the package is sufficient and the process proceeds to step 6. In step 6, an optimal package (PKG) can be obtained by conducting and clearing reliability evaluation tests that are not conducted in the above-described reliability evaluation analysis simulation, such as a mechanical cycle test, a drop impact test and the like.

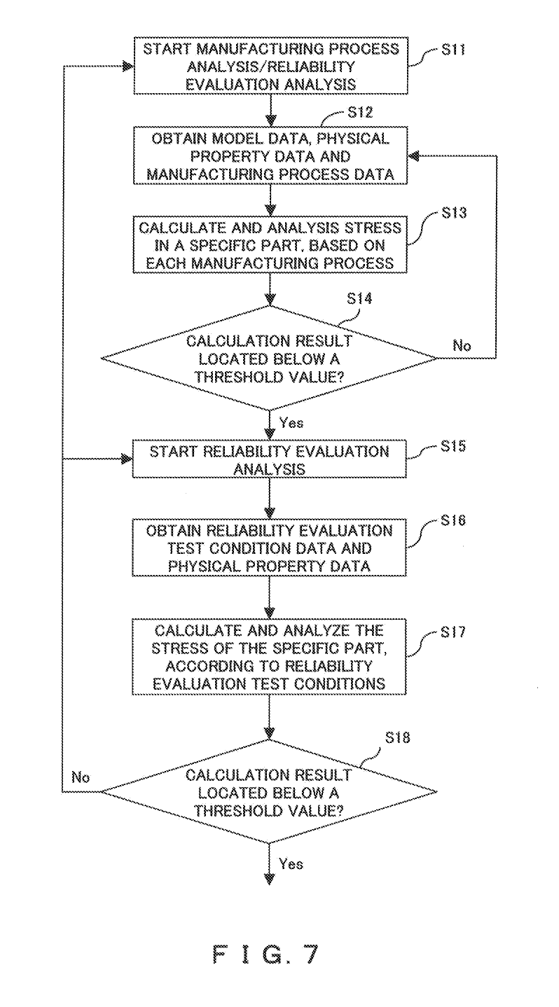

FIG. 7 is a flowchart showing the detailed reliability analysis method in the preferred embodiment of the present invention. In FIG. 7, in order for the designer of a package to conduct the reliability analysis of the package, firstly, in step (omitted “S” in FIG. 7) 11, as described with reference to FIG. 6, after the manufacturing process data setting unit 11 and the simulation model setting unit 13 which are shown in FIG. 3, set manufacturing process condition (manufacturing process data) and dimensions (model data), respectively, and the reliability evaluation test condition data setting unit 22 shown in FIG. 5 sets reliability evaluation test conditions, manufacturing process analysis/reliability evaluation analysis are started. In step 12, the set manufacturing process data and model data (dimensions) are obtained, and physical property data including the hygroscopic expansion, thermal shrinkage and the like of a constituting material is also obtained from the material database 12. Then, in step 13, each temperature- and time-dependent physical property data obtained from the material database 12 are taken in a computer, according to each manufacturing process and stress applied to the specific part of a package is calculated using a method, such as a finite element method and is analyzed. Then, in step 14, it is determined whether the calculation result of step 13 is located below a prescribed threshold value (for example, the fracture toughness value of a material). If the determination result is no, it is determined that the heat history aptitude of the package is insufficient and the process returns to step 12. Then, after the variety of conditions are modified and are selectively obtained, steps 12 and 13 are executed again.

If the determination result of step 14 is yes, it is determined that the heat history aptitude of the package is sufficient and the process proceeds to step 15. Then, reliability evaluation analysis is started. Then, in step 16, the reliability evaluation test condition data set in step 16 and each temperature- and time-dependent physical property data stored in the material database 21 are taken in. Then, in step 17, a computer calculates stress applied to the specific part of a package in a cold-heat impact test, a moisture absorption test and the like, using a calculation method, such as a finite element method or the like. Then, in step 18, it is determined whether the calculation result of step 17 is located below a prescribed threshold value (for example, the fracture toughness value of a material). If the determination result is no, it is determined that the heat history aptitude is insufficient and the process returns to step 11 or 15. After a variety of conditions including the manufacturing process are modified again based on the reliability evaluation analysis result with reference to the initially set reliability evaluation test conditions and each of the variety of conditions is selectively obtained, steps 11 and after or steps 15 and after are executed. If the determination result of step 18 is yes, it is determined that the heat history aptitude of the package is sufficient and the process proceeds to a subsequent step. In the subsequent step, reliability evaluation tests that are nor conducted in the above-described reliability evaluation analysis simulation, such as a mechanical cycle test, a drop impact test and the like, are conducted, which is not shown in FIG. 7, and by clearing these, an optimal package (PKG) can be obtained.

What is claimed is:

1. A reliability analysis system, comprising:
a database for storing time- and temperature-dependent changes due to heat and humidity of a resin material, as physical property data;
a manufacturing process analyzing unit for taking in physical property data from the database, based on a predetermined package model and process conditions, according to a manufacturing process, calculating stress applied to a specific part of the model and analyzing a heat history aptitude of a package; and
a reliability evaluation/analysis unit for taking in physical property data from the database, based on predetermined reliability evaluation conditions, calculating stress applied to a specific part of the model and analyzing a heat history aptitude of a package.

2. The reliability analysis system according to claim 1, wherein
the manufacturing process analysis unit can take in the time- and temperature-dependent physical property data in the manufacturing process from the database, calculate a stress value applied to a specific part of the model, using a prescribed calculation method and analyze a heat history aptitude of a package, based on the stress value.

3. There liability analysis system according to claim 1, wherein
when the stress value of the manufacturing process analysis unit exceeds a prescribed threshold value, the manufacturing process analysis unit can modify a material stored in the database, modify the package model in which conditions are set or calculate physical property data which is located below the threshold value, by changing the set process conditions.

4. A reliability analysis method, comprising:
setting model data, process conditions and reliability evaluation test conditions and also obtaining the set model data, process conditions and temperature- and time-dependent physical property data of a manufacturing process;
taking in the obtained process conditions, model data and physical property data in a computer and calculating and analyzing stress applied to the specific part of the model in the manufacturing process;
determining whether the stress of the manufacturing process is located below a prescribed threshold value and determining heat history aptitude of a package;
taking in each temperature- and time-dependant physical property data of set reliability evaluation test conditions in a computer and calculating and analyzing stress applied to the specific part of the model in reliability evaluation;
determining whether the analyzed stress is located below a prescribed threshold value; and
if the analyzed stress is located below the threshold value, determining that the heat history aptitude of a package is sufficient.

5. A reliability analysis program which analyzes reliability of a package, for enabling a computer to execute a step, the step comprising:
inputting model data, process conditions and reliability evaluation test conditions;
obtaining the inputted model data and process conditions and temperature- and time-dependent physical property data of a manufacturing process from a database;
calculating and analyzing stress applied to a specific part of the model in the manufacturing process, based on the obtained process conditions, model data and physical property data;
determining whether the analyzed stress is located below a prescribed threshold value and determining heat history aptitude of the package;
obtaining each temperature-and time-dependent physical property data of the inputted reliability evaluation test conditions from the database;
calculating and analyzing the stress applied to the specific part of the model in reliability evaluation;
determining whether the analyzed stress is located below a prescribed threshold value; and
if the analyzed stress is located below the prescribed threshold value, determining that the heat history aptitude of the package is sufficient.
